(19) United States
(12) Patent Application Publication
(10) Pub. No.: US 2026/0302666 A1
(43) Pub. Date: Oct. 1, 2026

(54) CONNECTION ASSEMBLY, CIRCUIT BOARD ASSEMBLY, AND ELECTRONIC DEVICE

(71) Applicants: HON HAI PRECISION INDUSTRY CO., LTD., New Taipei (TW); HONGFUJIN PRECISION INDUSTRY (WUHAN) CO., LTD., Wuhan (CN)

(72) Inventors: YI-SHENG LIN, New Taipei (TW); ZHAO-LI ZHANG, Wuhan (CN)

(21) Appl. No.: 19/576,590

(22) Filed: Mar. 24, 2026

(30) Foreign Application Priority Data
Mar. 28, 2025 (CN) 202520572265.2

(51) Int. Cl. H01R 12/73

(52) U.S. Cl. CPC H01R 12/737

(57) ABSTRACT

The present application relates to the field of electronic device technology, and provides a connection assembly, a circuit board assembly, and an electronic device. The connection assembly includes a connector and a protective cover, a bottom of the connector is configured to connect to a circuit board, a top surface of the connector has a connection groove, the connection groove is configured to connect to a target component, and the target component has a positioning portion. The protective cover sleeves on the connector, the protective cover has at least one first fixing portion configured to connect to the circuit board. The connector defines a first positioning hole, and the first positioning hole is configured to position the positioning portion along a first direction, and the protective cover defines a second positioning hole, and the second positioning hole is configured to position the positioning portion along the first direction.

### FIELD

The present application relates to the field of electronic device technology, and provides a connection assembly, a circuit board assembly, and an electronic device.

### BACKGROUND

A connector is disposed on a circuit board and is used to connect a graphics card and a memory stick. Some known connectors have a problem of low connection stability of the graphics card and the memory stick.

### SUMMARY OF THE DISCLOSURE

The disclosure provides a connection assembly, a circuit board assembly, and an electronic device.

In a first aspect, an embodiment of the disclosure provides a connection assembly. The connection assembly includes a connector and a protective cover, a bottom of the connector is configured to connect to a circuit board, a top surface of the connector defines a connection groove, the connection groove is configured to connect to a target component, and the target component has a positioning portion. Wherein the protective cover sleeves on the connector, the protective cover has at least one first fixing portion configured to connect to the circuit board. the connector defines a first positioning hole, and the first positioning hole is configured to position the positioning portion along a first direction; and the protective cover defines a second positioning hole, and the second positioning hole is configured to position the positioning portion along the first direction.

In a second aspect, an embodiment of the disclosure provides a circuit board assembly. The circuit board assembly includes a circuit board and a connection assembly, the connection assembly, comprises a connector and a protective cover, a bottom of the connector connects the circuit board, a top surface of the connector defines a connection groove, the connection groove is configured to connect to a target component, and the target component has a positioning portion; wherein the protective cover sleeves on the connector, the protective cover has at least one first fixing portion configured to connect to the circuit board; the connector defines a first positioning hole, and the first positioning hole is configured to position the positioning portion along a first direction; and the protective cover defines a second positioning hole, and the second positioning hole is configured to position the positioning portion along the first direction.

In a third aspect, an embodiment of the disclosure provides an electronic device. The electronic device includes a chassis, a target component and a circuit board assembly; the circuit board assembly is disposed in the chassis, and the circuit board assembly comprises a circuit board and a connection assembly, the connection assembly, comprises a connector and a protective cover, a bottom of the connector connects the circuit board, a top surface of the connector defines a connection groove, the connection groove connects the target component, and the target component has a positioning portion; wherein the protective cover sleeves on the connector, the protective cover has at least one first fixing portion configured to connect to the circuit board; the connector defines a first positioning hole, and the first positioning hole is configured to position the positioning portion along a first direction; and the protective cover defines a second positioning hole, and the second positioning hole is configured to position the positioning portion along the first direction.

### BRIEF DESCRIPTION OF THE DRAWINGS

FIG. 1 is a cross-sectional view of an electronic device according to an embodiment of the present application.

FIG. 2 is a partial enlarged schematic view of a portion II in FIG. 1.

FIG. 3 is a three-dimensional structural schematic view of a connection assembly according to an embodiment of the present application.

FIG. 4 is an exploded structural schematic view of a connection assembly according to the embodiment shown in FIG. 3.

FIG. 5 is a partial exploded structural schematic view of a connection assembly according to the embodiment shown in FIG. 3.

FIG. 6 is a three-dimensional structural schematic view of a connection assembly according to the embodiment shown in FIG. 3 from another viewing angle.

FIG. 7 is a cross-sectional view of a connection assembly according to the embodiment shown in FIG. 3.

FIG. 8 is a partial exploded structural schematic view of a connector and a protective cover according to an embodiment of the present application.

FIG. 9 is a cross-sectional view of a connection assembly according to an embodiment of the present application from another viewing angle.

FIG. 10 is partial exploded structural schematic view of a connector and a protective cover according to an embodiment of the present application.

FIG. 11 is a partial structural schematic view of one end of the connection assembly according to an embodiment of the present application.

### DETAILED DESCRIPTION

The technical scheme in the embodiment of the disclosure will be described in combination with the attached drawings in the embodiment of the application. Obviously, the described embodiments are only part of the embodiments of the application, not all embodiments.

It should be noted that when an element is said to be "fixed to" another element, it can be directly on another element or there can be an intervening element. When a component is "connected" to another component, it can be directly connected to another component or there may be intermediate components at the same time. When a component is "set on" another component, it can be set directly on another component or there may be intervening components at the same time. The terms "vertical," "horizontal," "left," "right," and similar expressions used in this paper are for illustrative purposes only.

Unless otherwise defined, all technical and scientific terms used herein have the same meanings as those commonly understood by those skilled in the technical field of the application. The terms used in the specification of the application herein are only for the purpose of describing specific embodiments and are not intended to limit the application. The term "and / or" as used herein includes any and all combinations of one or more related listed items.

Some embodiments of the disclosure are described in detail. Without conflict, the following embodiments and features in the embodiments can be combined with each other.

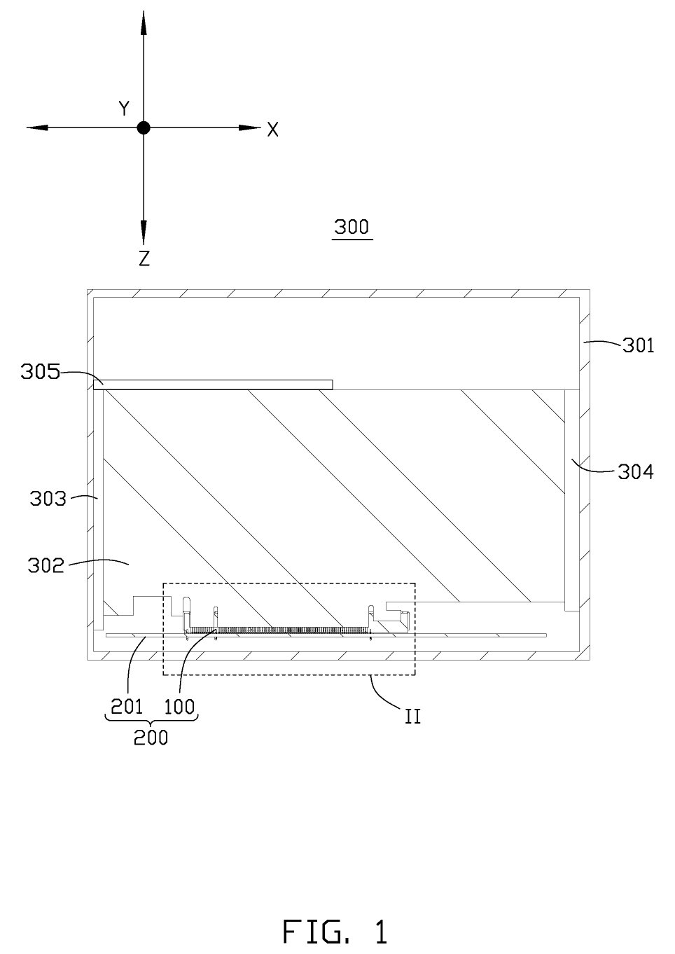

Referring to FIG. 1, the present embodiment provides an electronic device 300. The electronic device 300 is a computer host or a server. The electronic device 300 includes a chassis 301, a circuit board assembly 200, and a target component 302. The circuit board assembly 200 is disposed in the chassis 301. The circuit board assembly 200 includes a circuit board 201 and a connection assembly 100. The circuit board 201 is disposed in the chassis 301. The connection assembly 100 connects the circuit board 201. The target component 302 mounts to the connection assembly 100. The target component 302 is a graphics card, a memory stick or a memory.

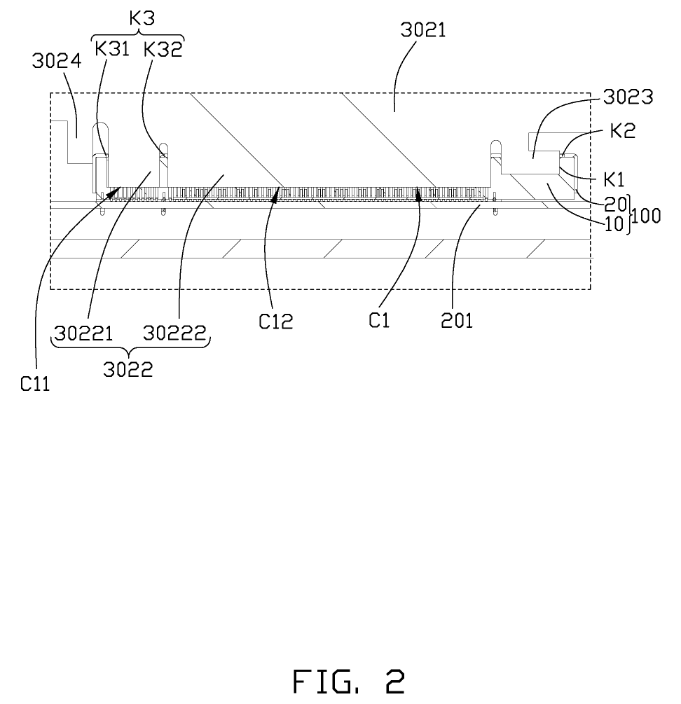

Referring to FIG. 2, the connection assembly 100 includes a connector 10 and a protective cover 20. A bottom of the connector 10 connects the circuit board 201. A top surface P11 of the connector 10 defines a connection groove C1, the connection groove C1 extends along a first direction X, the connection groove C1 connects the target component 302. The target component 302 includes a positioning portion 3023. The protective cover 20 sleeves on the connector 10. The connector 10 has a positioning hole K1, and the first positioning hole K1 is configured to position the positioning portion 3023 along the first direction X. The protective cover 20 defines a second positioning hole K2, and the second positioning hole K2 is configured to position the positioning portion 3023 along the first direction X.

The first positioning hole K1 and the second positioning hole K2 can position the positioning portion 3023, the target component 302 stably connects the connector 10, thereby reducing a possibility of the target component 302 oscillating in the connection groove C1 and damaging the connector 10, thereby improving a service life of the connector 10. The protective cover 20 can enhance a strength of the connector 10, enabling the connector 10 to remain undamaged when bearing an impact of the target component 302. This allows the connection assembly 100 to support a target component 302 of greater weight, and ensuring a operational reliability of the connector 10.

In one embodiment, the first positioning hole K1 is a blind hole. In other embodiments, the first positioning hole K1 may be a through hole.

In one embodiment, a material of the protective cover 20 is stainless steel, and the stainless steel can improve a protective effect on the connector 10.

In some embodiments, referring to FIG. 2, the electronic device 300 further includes a first limiting member 303, a second limiting member 304, and a third limiting member 305. The first limiting member 303 connects the chassis 301 and one end of the target component 302 along the first direction X. The second limiting member 304 connects the chassis 301 and another end of the target component 302 along the first direction X. The first limiting member 303 and the second limiting member 304 are configured to limit the target component 302 along the first direction X. The first limiting member 303 and the second limiting member 304 cooperate with each other to provide a positioning effect on the target component 302 in the first direction X. The third limiting member 305 connects the chassis 301, and the third limiting member 305 is spaced from the circuit board 201. The third limiting member 305 is configured to press the target component 302 against the connector 10 along a third direction Z, and further improve a mounting stability of the target component 302.

In some embodiments, referring to FIG. 2, the target component 302 includes a printed circuit board 3021. The printed circuit board 3021 includes a board body, a gold finger portion 3022, and the positioning portion 3023. The gold finger portion 3022 connects the board body, and the gold finger portion 3022 is plugged into the connection groove C1. The positioning portion 3023 connects the board body. The positioning portion 3023 is a non-functional portion on the printed circuit board 3021. The positioning portion 3023 is received in the first positioning hole K1 and the second positioning hole K2. By positioning the positioning portion 3023, damage to the gold finger portion 3022 of the printed circuit board 3021 can be prevented. Meanwhile, some existing standard graphics cards have the positioning portion 3023, and by utilizing the positioning portion 3023 to position the target component 302, a versatility of the connection assembly 100 can be significantly improved.

In some embodiments, referring to FIG. 2, the printed circuit board 3021 further includes a clamping portion 3024. The clamping portion 3024 is defined on a side of the gold finger portion 3022 away from the positioning portion 3023 along the first direction X. The clamping portion 3024 abuts against the protective cover 20 along the first direction X, and engages with the protective cover 20 in the first direction X. This further improving a limiting reliability of the connection assembly 100 and the target component 302 along the first direction X.

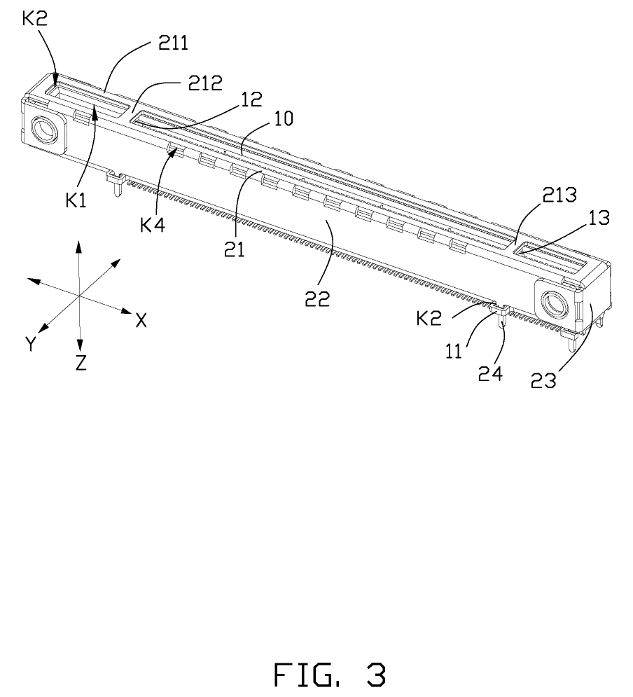

In some embodiments, referring to FIGS. 2 and 3, the gold finger portion 3022 includes a first portion 30221 and a second portion 30222 spaced along the first direction X. A first separating portion 12 is provided on a groove bottom surface P12 of the connection groove C1. The first separating portion 12 divides the connection groove C1 into a first groove C11 and a second groove C12 spaced along the first direction X. The first portion 30221 is received in the first groove C11. The second portion 30222 is received in the second groove C12.

This reducing an oscillation of the target member 302, alleviating an impact of the shaking of the target component 302 on the first separating portion 12, and further improving a protection of the first separating portion 12.

In some embodiments, referring to FIG. 3, the protective cover 20 further defines a clearance hole K3. The clearance hole K3 corresponds to the connection groove C1. The gold finger portion 3022 passes through the clearance hole K3, and is received in the connection groove C1.

In one embodiment, the protective cover 20 has a first intermediate portion 212 protruding from a hole surface of the clearance hole K3. The first intermediate portion 212 divides the clearance hole K3 into a first hole K31 and a second hole K32 spaced from each other. The first hole K31 corresponds to the first groove C11, and the second hole K32 corresponds to the second groove C12.

In one embodiment, an orthographic projection of the first hole K31 along a third direction Z covers an orthographic projection of the first groove C11 along the third direction Z, and an orthographic projection of the second hole K32 along the third direction Z covers an orthographic projection of the second groove C12 along the third direction Z. Therefore, the printed circuit board 3021 can smoothly mount into the first groove C11 and the second groove C12, thereby improving a smoothness of insertion and removal of the printed circuit board 3021.

In some embodiments, referring to FIG. 3, the connector 10 further has a second separating portion 13. The second separating portion 13 is defined between the connection groove C1 and the first positioning hole K1 along the first direction X. The protective cover 20 further has a second intermediate portion 213. The second intermediate portion 213 is defined between the second positioning hole K2 and the clearance hole K3 along the first direction X.

In some embodiments, the first positioning hole K1 is spaced from the connection groove C1 along the first direction X. The second positioning hole K2 is spaced from the clearance hole K3 along the first direction X. As such, the connector 10 may be directly adapted to some known graphics cards, improving a versatility of the connection assembly 100.

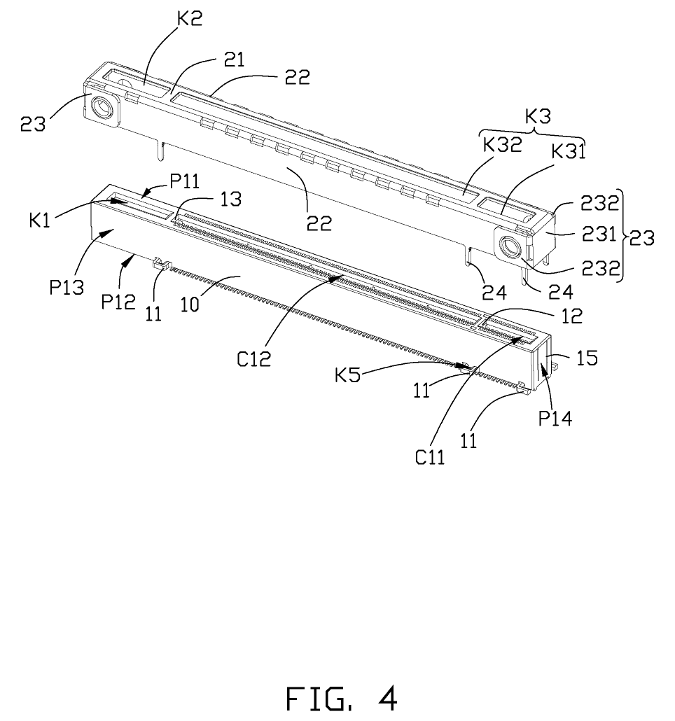

In some embodiments, referring to FIGS. 3 and 4, the connector 10 includes a bottom surface P12, the bottom surface P12 and the top surface P11 is opposite to each other along a third direction Z. The bottom surface P12 is disposed on the circuit board 201. The connection groove C1 is on the top surface P11, and the first positioning hole K1 is on the top surface P11. The connector 10 further includes a side surface P13 connecting the top surface P11 and the bottom surface P12. The side surface P13 and two end surfaces P14 are opposite to each other along the first direction X. The bottom surface P12, the top surface P11, the two end surfaces P14, and two side surfaces P13 are sequentially connected to form an outer surface of the connector 10.

The protective cover 20 further includes a top wall 21 and a side wall 22. The top wall 21 of the protective cover 20 is disposed on the top surface P11 of the connector 10, the side wall 22 of the protective cover 20 corresponds to the side surface P13 of the connector 10, and the second positioning hole K2 and the clearance hole K3 are on the top wall 21. Therefore, the protective cover 20 covering over the connector 10, and providing a strengthening effect on the top surface P11 and the side surface P13 of the connector 10. In one embodiment, the top wall 21 includes a frame body 211, a first intermediate portion 212, and a second intermediate portion 213. The first intermediate portion 212 and the second intermediate portion 213 are spaced apart and disposed within the frame body 211 to define the clearance hole K3 and the second positioning hole K2.

In some embodiments, referring to FIG. 3, a connection between the top wall 21 and the side wall 22 defines a plurality of bending holes K4. The plurality of bending holes K4 is arranged at intervals along the first direction X. The bending hole K4 can facilitate a bending processing of the top wall 21 and the side wall 22, and providing a heat dissipation effect for the connector 10.

In some embodiments, referring to FIG. 4, the protective cover 20 further includes two connecting walls 23. Each of the two connecting walls 23 connects to a side of the top wall 21 along the first direction X, one of the two connecting walls 23 connects one end of two side walls 22, and another one of the two connecting walls 23 connects another end of the two side walls 22.

In one embodiment, referring to FIG. 4, the connecting wall 23 includes a first segment 231 and two second segments 232. The first segment 231 connects the top wall 21, the first segment 231 corresponds to an end surface P14 of the connector 10 along the first direction X, and each of the two second segments 232 connects a side of the first segment 231, and each of the two second segments 232 corresponds and connects one of the two side walls 22.

In one embodiment, the second segment 232 is defined on a side of the side wall 22 away from the connector 10. This improving a convenience of riveting processing of the second segment 232 and the side wall 22.

In one embodiment, the first segment 231 and the side wall 22 can be connected through connection manners such as riveting and welding.

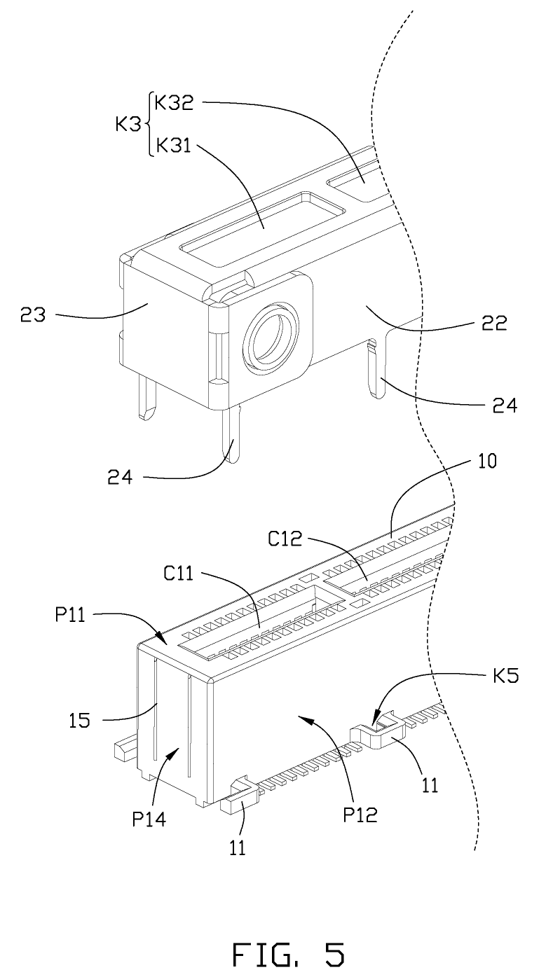

In some embodiments, referring to FIGS. 4 and 5, end surfaces P14 at two ends of the connector 10 along the first direction X are both protruded with a limiting portion 15. The first segment 231 cooperates with a corresponding limiting portion 15 to improve a connection reliability between the protective cover 20 and the connector 10.

In some embodiments, referring to FIGS. 4 and 5, the protective cover 20 has at least one first fixing portion 24. The first fixing portion 24 connects the circuit board 201. The protective cover 20 limits the connector 10 to the circuit board 201 along a third direction Z, thereby improving a strengthening effect on the connector 10.

In one embodiment, the first fixing portion 24 can be welded and connected to the circuit board 201.

In one embodiment, the at least one first fixing portion 24 includes a plurality of first fixing portions 24 distributed on two sides of the protective cover 20 along a second direction Y. This improving a connection reliability between the protective cover 20 and the circuit board 201, so that the protective cover 20 can withstand a larger impact and remain connected to the circuit board 201.

In one embodiment, one side of the protective cover 20 along the second direction Y has three first fixing portions 24 spacing apart from each other along the first direction X. Another side of the protective cover 20 along the second direction Y has three first fixing portions 24 spacing apart from each other along the first direction X.

In some embodiments, referring to FIGS. 4 and 5, the connector 10 has a second fixing portion 11, the first fixing portion 24 connects to the second fixing portion 11 and the circuit board 201.

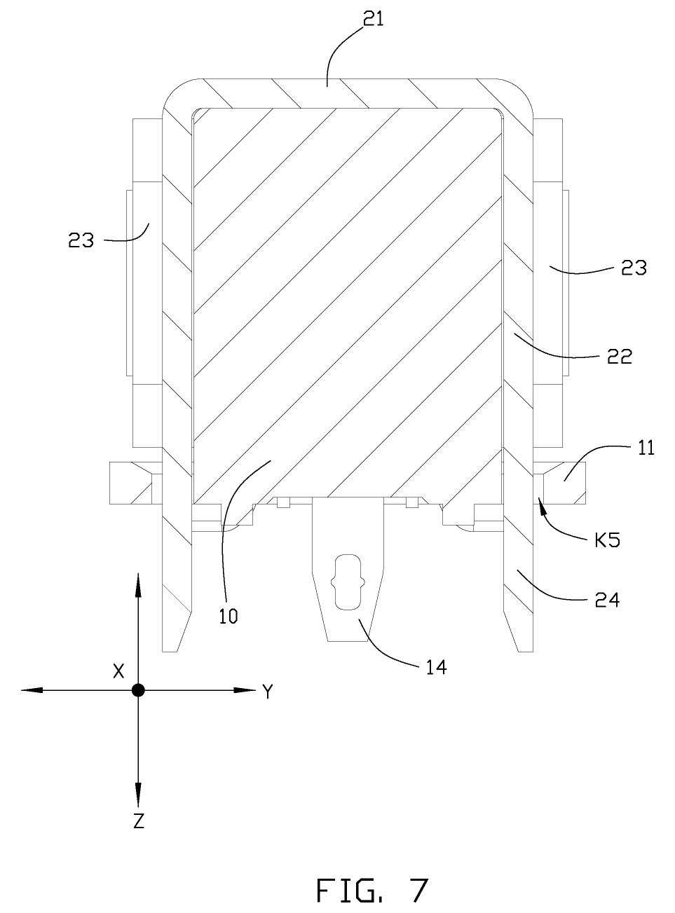

In one embodiment, the second fixing portion 11 defines a via hole K5 (also visible in FIG. 7). The first fixing portion 24 passes through the via hole K5, and the first fixing portion 24 connects to the circuit board 201.

In one embodiment, the second fixing portion 11 is an L-shaped structure. The second fixing portion 11 and the side surface P13 of the connector 10 form the via hole K5.

In one embodiment, the connector 10 has a plurality of second fixing portions 11, the plurality of first fixing portions 24 pass through a corresponding second fixing portion 11, and are welded to the circuit board 201. In other embodiments, the first fixing portion 24 and the second fixing portion 11 are simultaneously connected to the circuit board 201 through welding.

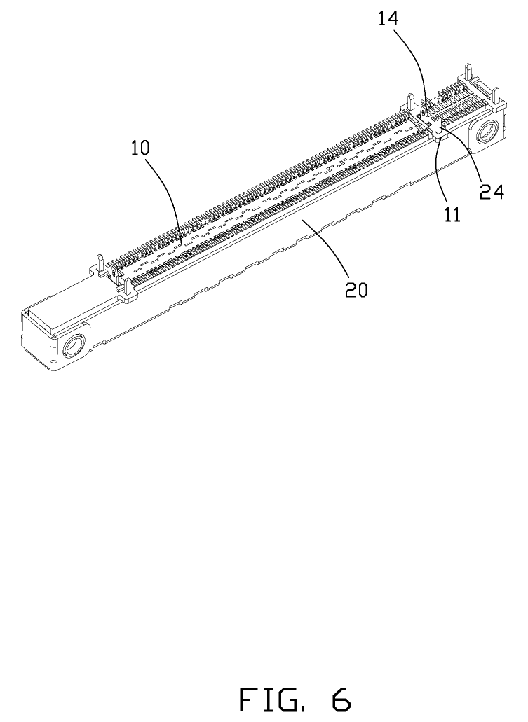

In some embodiments, referring to FIGS. 6 and 7, the connector 10 further has a third fixing portion 14. The third fixing portion 14 is protruded from the bottom surface P12. The third fixing portion 14 connects the circuit board 201. The third fixing portion 14 can connect the circuit board 201 through a plurality of connection manners such as snap-fitting or welding.

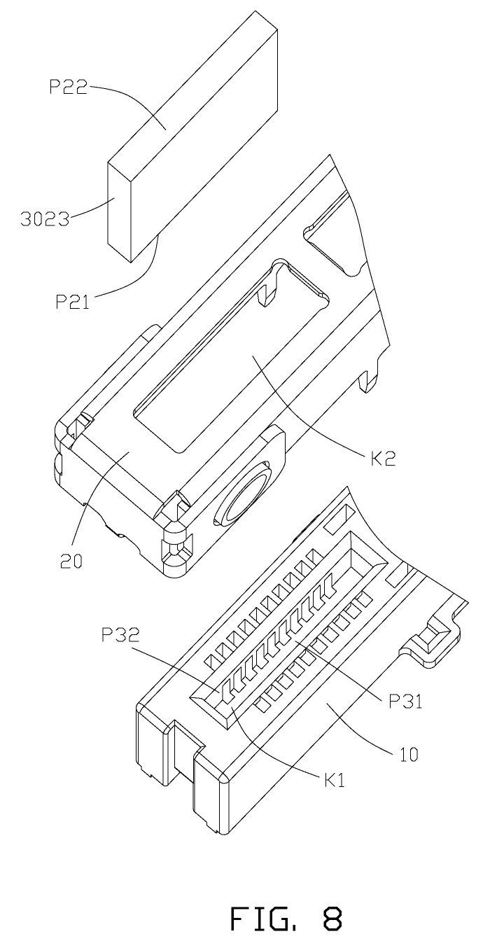

In some embodiments, referring to FIG. 8, the positioning portion 3023 defines an abutting surface P21 and an outer peripheral surface P22. The outer peripheral surface P22 connects an edge of the abutting surface P21. The first positioning hole K1 is a blind hole, the blind hole defines a hole bottom surface P31 and a hole side surface P32, the hole side surface P32 connects an edge of the hole bottom surface P31, the abutting surface P21 abuts against the hole bottom surface P31, and the outer peripheral surface P22 abuts against the hole side surface P32. The first positioning hole K1 can stably and reliably clamp the positioning portion 3023, improving a positioning reliability of the positioning portion 3023.

In some embodiments, referring to FIG. 8, the second positioning hole K2 includes a through hole, edges on two sides of the through hole along the first direction X are correspondingly arranged with edges on two sides of the blind hole along the first direction X, and edges on two sides of the through hole along a second direction Y exceed an edge on two sides of the blind hole along the second direction Y. Thereby, the positioning portion 3023 can smoothly pass through the second positioning hole K2 and cooperate with the first positioning hole K1.

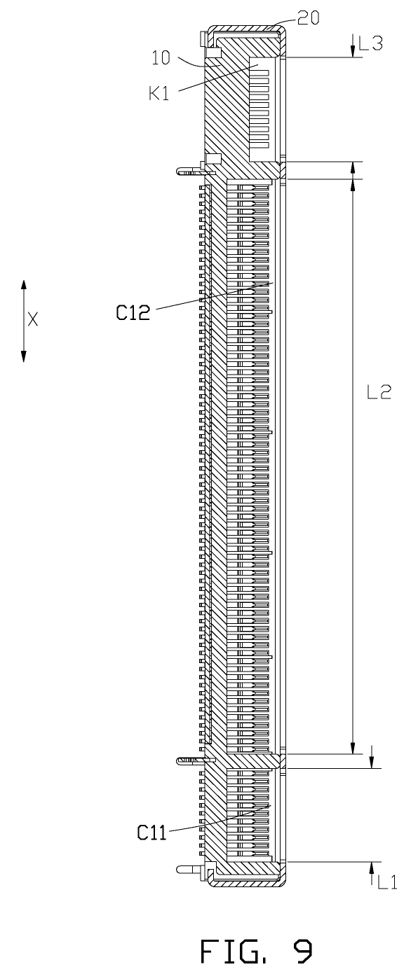

In some embodiments, referring to FIG. 9, a dimension of the first groove C11 along the first direction X is L1, and 10mm≤L1≤13mm. L1 may be any one of 10mm, 11mm, 12mm, and 13mm.

In some embodiments, referring to FIG. 9, a dimension of the second groove C12 along the first direction X is L2, and 70mm≤L2≤74mm. L2 may be any one of 70mm, 71mm, 72mm, 73mm, and 74mm.

In some embodiments, referring to FIG. 9, a dimension of the first positioning hole K1 along the first direction X is L3, and 12mm≤L3≤15mm. L3 may be any one of 12mm, 13mm, 14mm, and 15mm.

In one embodiment, a dimension of the first hole K31 along the first direction X is greater than a dimension of the first groove C11 along the first direction X. A dimension of the second hole K32 along the first direction X is greater than a dimension of the second groove C12 along the first direction X. A dimension of the second positioning hole K2 along the first direction X is greater than a dimension of the first positioning hole K1 along the first direction X. For example, a dimension of the first groove C11 along the first direction X is 11.65mm. A dimension of the first hole K31 along the first direction X is 11.87mm. A dimension of the second groove C12 along the first direction X is 71.65mm. A dimension of the second hole K32 along the first direction X is 71.79mm. A dimension of the first positioning hole K1 along the first direction X is 13mm. A dimension of the second positioning hole K2 along the first direction X is 13.22mm.

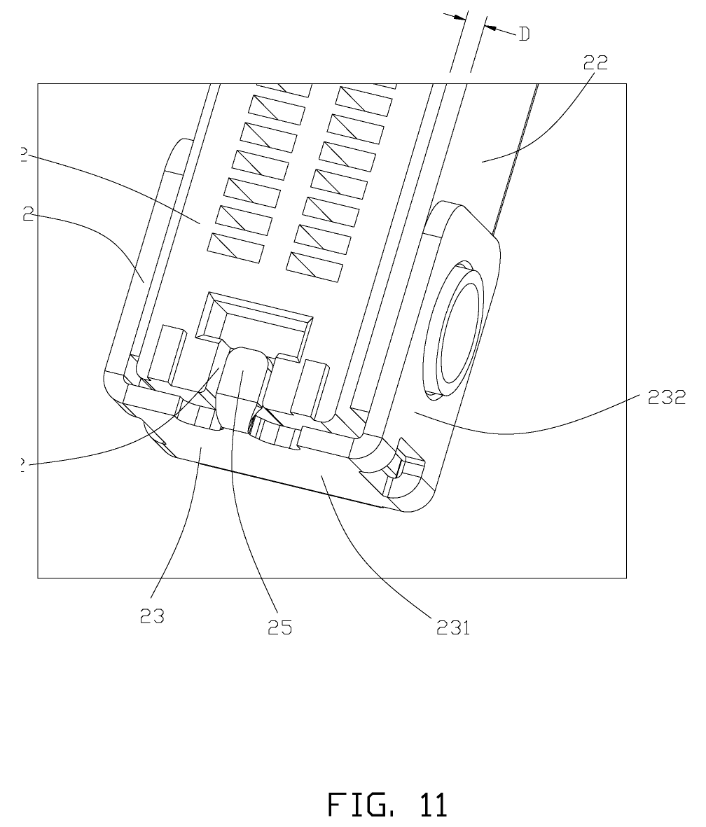

In some embodiments, referring to FIG. 11, a wall thickness of the protective cover 20 is D, and 0.5mm≤D≤3mm. D may be any one of 0.5mm, 0.6mm, 0.7mm, 0.8mm, 0.9mm, 1.0mm, 1.1mm, 1.2mm, 1.3mm, 1.4mm, 1.5mm, 1.6mm, 1.7mm, 1.8mm, 1.9mm, 2.0mm, 2.1mm, 2.2mm, 2.3mm, 2.4mm, 2.5mm, 2.6mm, 2.7mm, 2.8mm, 2.9mm, and 3.0mm. The wall thickness of the protective cover 20 is thicker, and further improving a protective effect on the connector 10.

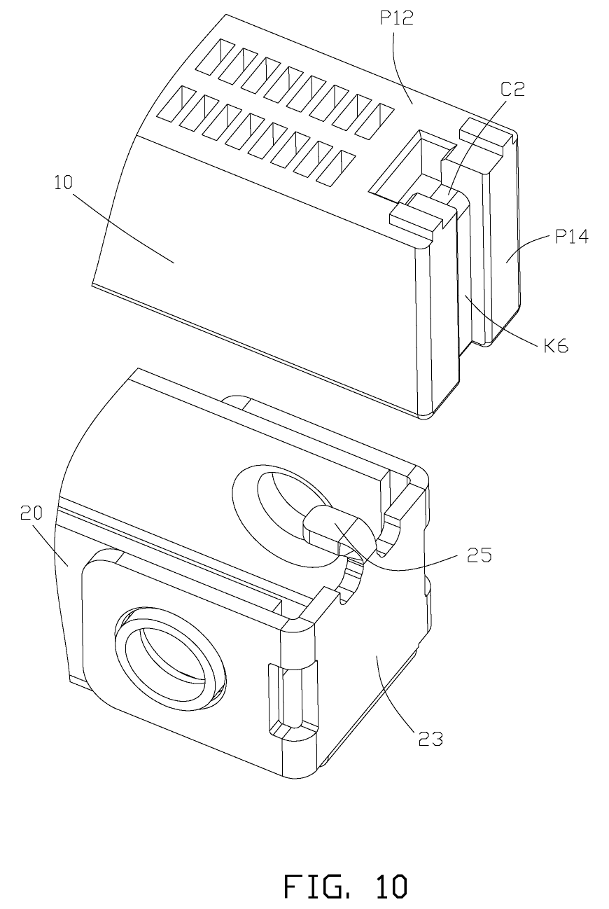

In some embodiments, referring to FIGS. 10 and 11, the connector 10 further includes two end surfaces P14. One of the two end surfaces P14 connects one end of the bottom surface P12 along the first direction X and connects one end of the top surface P11 along the first direction X, and another one of the two end surfaces P14 connects another end of the bottom surface P12 along the first direction X and connects another end of the top surface P11 along the first direction X.

The protective cover 20 further includes a locking portion 25 on a side of each connecting wall 23 close to the bottom surface P12, the connector 10 further includes a locking groove C2 on each of two ends of the bottom surface P12, the locking groove C2 extends along a length direction of the bottom surface P12, each of the two end surfaces P14 of the connector 10 defines an opening K6 communicating with the locking groove C2, the locking portion 25 passes through the opening K6, and abuts against a bottom surface of the locking groove C2. Thereby, a cooperation of the locking portion 25 and the locking groove C2 improving a connection reliability between the connecting wall 23 and the connector 10. The locking portion 25 may also be received in the locking groove C2, thereby avoiding an interference between the locking portion 25 and the printed circuit board 302.

In one embodiment, the locking portion 25 is bent and connected to the first segment 231.

What is claimed is:

1. A connection assembly, comprising a connector and a protective cover, wherein a bottom of the connector is configured to connect to a circuit board, a top surface of the connector defines a connection groove, the connection groove is configured to connect to a target component, and the target component has a positioning portion;
wherein the protective cover sleeves on the connector, the protective cover comprises at least one first fixing portion configured to connect to the circuit board;
the connector defines a first positioning hole configured to position the positioning portion along a first direction; and the protective cover defines a second positioning hole, and the second positioning hole is configured to position the positioning portion along the first direction.

2. The connection assembly according to claim 1, wherein the at least one first fixing portion comprises a plurality of first fixing portions distributed on two sides of the protective cover.

3. The connection assembly according to claim 1, wherein the protective cover further defines a clearance hole, the first positioning hole of the connector is spaced from the connection groove along the first direction, and the second positioning hole of the protective cover is spaced from the clearance hole along the first direction.

4. The connection assembly according to claim 1, wherein, the connector comprises a bottom surface, the bottom surface is opposite to the top surface, the first positioning hole is on the top surface.

5. The connection assembly according to claim 4, wherein, the connector further comprises a side surface connecting the top surface and the bottom surface;
the protective cover further comprises a top wall and a side wall, the top wall of the protective cover is disposed on the top surface of the connector, the side wall connects the top wall, the side wall of the protective cover corresponds to the side surface of the connector, and the second positioning hole is on the top wall.

6. The connection assembly according to claim 5, wherein, the protective cover comprises two side walls, and each of the two side walls is connected to a side of the top wall along a second direction;
the protective cover further comprises two connecting walls, each of the two connecting walls is connected to an end of the top wall along the first direction, one of the two connecting walls connects one end of the two side walls, and another one of the two connecting walls connects another end of the two side walls.

7. The connection assembly according to claim 6, wherein each of the two connecting walls includes a first segment and two second segments, the first segment connects the top wall, the first segment corresponds to an end surface of the connector along the first direction, and each of the two second segments connects a side of the first segment, and each of the two second segments corresponds and connects one of the two side walls.

8. The connection assembly according to claim 6, wherein the connector further comprises two end surfaces, one of the two end surfaces connects one end of the bottom surface along the first direction and connects one end of the top surface along the first direction, and another one of the two end surfaces connects another end of the bottom surface along the first direction and connects another end of the top surface along the first direction;
the protective cover further comprises a locking portion on a side of each of the two connecting walls close to the bottom surface, the connector further comprises a locking groove on each of two ends of the bottom surface, the locking groove extends along a length direction of the bottom surface, each of the two end surfaces of the connector defines an opening communicating with the locking groove, the locking portion passes through the opening, and abuts against a bottom surface of the locking groove.

9. The connection assembly according to claim 1, wherein, a wall thickness of the protective cover is D, and 0.5mm≤D≤3mm.

10. The connection assembly according to claim 1, wherein, the connector further comprises a first separating portion on a groove bottom surface of the connection groove, the first separating portion divides the connection groove into a first groove and a second groove spaced along the first direction, and the first positioning hole is defined on a side of the second groove away from the first groove; a dimension of the first groove along the first direction is L1, and 10mm≤L1≤13mm;
a dimension of the second groove along the first direction is L2, and 70mm≤L2≤74mm; and
a dimension of the first positioning hole along the first direction is L3, and 12mm≤L3≤15mm.

11. The connection assembly according to claim 1, wherein, the connector further comprises a second fixing portion, the first fixing portion connects to the second fixing portion and the circuit board.

12. A circuit board assembly, comprising a circuit board and a connection assembly, the connection assembly comprising a connector and a protective cover, wherein a bottom of the connector connects the circuit board, a top surface of the connector has a connection groove, the connection groove is configured to connect to a target component, and the target component has a positioning portion;
wherein the protective cover sleeves on the connector, the protective cover comprises at least one first fixing portion configured to connect to the circuit board;
the connector defines a first positioning hole configured to position the positioning portion along a first direction; and the protective cover defines a second positioning hole, and the second positioning hole is configured to position the positioning portion along the first direction.

13. An electronic device, comprises a chassis, a target component and a circuit board assembly; the circuit board assembly is disposed in the chassis, and the circuit board assembly comprises a circuit board and a connection assembly, the connection assembly comprising a connector and a protective cover,
wherein a bottom of the connector is configured to connect to a circuit board, a top surface of the connector defines a connection groove, the connection groove is configured to connect to a target component, and the target component has a positioning portion;
wherein the protective cover sleeves on the connector, the protective cover comprises at least one first fixing portion configured to connect to the circuit board;
the connector defines a first positioning hole configured to position the positioning portion along a first direction; and the protective cover defines a second positioning hole, and the second positioning hole is configured to position the positioning portion along the first direction.

14. The electronic device according to claim 13, wherein the target component comprises a printed circuit board, the printed circuit board comprises a board body, a gold finger portion, and the positioning portion; the gold finger portion connects the board body, and the gold finger portion is received in the connection groove; the positioning portion connects the board body, the positioning portion is received in the first positioning hole and the second positioning hole.

15. The electronic device according to claim 13, wherein the positioning portion has an abutting surface and an outer peripheral surface, and the outer peripheral surface connects an edge of the abutting surface;
the first positioning hole is a blind hole, the blind hole has a hole bottom surface and a hole side surface, the hole side surface connects an edge of the hole bottom surface, the abutting surface abuts against the hole bottom surface, and the outer peripheral surface abuts against the hole side surface.

16. The electronic device according to claim 15, wherein, the second positioning hole is a through hole, two hole surfaces of the through hole along the first direction are correspondingly disposed with two hole surfaces of the blind hole along the first direction, and two hole surfaces of the through hole along a second direction exceed an edge of the blind hole.

17. The electronic device according to claim 13, wherein the connector comprises a bottom surface, the bottom surface is opposite to the top surface, the first positioning hole is on the top surface;
the connector further comprises a side surface connecting the top surface and the bottom surface; the protective cover further comprises a top wall and a side wall, the top wall of the protective cover is disposed on the top surface of the connector, the side wall connects the top wall, the side wall of the protective cover corresponds to the side surface of the connector, and the second positioning hole is on the top wall;
the connector further comprises two end surfaces, one of the two end surfaces connects one end of the bottom surface along the first direction and connects one end of the top surface along the first direction, and another one of the two end surfaces connects another end of the bottom surface along the first direction and connects another end of the top surface along the first direction;
the protective cover further comprises a locking portion on a side of each of the two connecting walls close to the bottom surface, the connector further comprises a locking groove on each of two ends of the bottom surface, the locking groove extends along a length direction of the bottom surface, each of the two end surfaces of the connector has an opening communicating with the locking groove, the locking portion passes through the opening, and abuts against a bottom surface of the locking groove.

18. The electronic device according to claim 13, wherein, a wall thickness of the protective cover is D, and 0.5mm≤D≤3mm.

19. The electronic device according to claim 13, wherein, the connector further comprises a first separating portion on a groove bottom surface of the connection groove, the first separating portion divides the connection groove into a first groove and a second groove spaced along the first direction, and the first positioning hole is defined on a side of the second groove away from the first groove.

20. The electronic device according to claim 19, wherein, a dimension of the first groove along the first direction is L1, and 10mm≤L1≤13mm;
and/or a dimension of the second groove along the first direction is L2, and 70mm≤L2≤74mm;
and/or a dimension of the first positioning hole along the first direction is L3, and 12mm≤L3≤15mm.
